(19) United States
(12) Patent Application Publication
(10) Pub. No.: US 2025/0008430 A1
(43) Pub. Date: Jan. 2, 2025

(54) USER EQUIPMENT POWER AND QUALITY OF SERVICE MANAGEMENT USING ARTIFICIAL INTELLIGENCE

(71) Applicant: Samsung Electronics Co., Ltd., Suwon-si (KR)

(72) Inventors: Yuqiang Heng, Plano, TX (US); Anum Ali, Frisco, TX (US); Vutha Va, Plano, TX (US); Priyabrata Parida, Dallas, TX (US); Boon Loong Ng, Plano, TX (US)

(21) Appl. No.: 18/523,860

(22) Filed: Nov. 29, 2023

Related U.S. Application Data
(60) Provisional application No. 63/523,495, filed on Jun. 27, 2023.

(51) Int. Cl. H04W 52/26; H04W 24/02

(52) U.S. Cl. CPC H04W 52/0209; H04W 24/02

(57) ABSTRACT

A method includes determining a preferred configuration of a user equipment (UE) based on side information about the UE. The method also includes sending the preferred configuration of the UE to a base station via a UE assistance information (UAI) framework. The method further includes receiving a new configuration of the UE from the base station after the base station determines the new configuration based on the preferred configuration. The method also includes configuring the UE according to the new configuration.

### CROSS-REFERENCE TO RELATED APPLICATIONS AND CLAIM OF PRIORITY

The present application claims priority to U.S. Provisional Patent Application No. 63/523,495 filed on Jun. 27, 2023. The content of the above-identified patent document is incorporated herein by reference.

### TECHNICAL FIELD

The present disclosure relates generally to wireless communication systems and, more specifically, the present disclosure relates to a method and apparatus for user equipment (UE) power and quality of service (QoS) management using artificial intelligence (AI).

### BACKGROUND

The 5th generation (5G) cellular communication systems deliver high data rate and low latency to support a wide range of the applications, mainly achieved through means such as larger bandwidths and more antennas. On the other hand, the increase in power consumption resulting from various 5G applications and techniques is particularly challenging for UEs that rely on battery power. In an effort to overcome this challenge, Release 16 of 3GPP specifications provides a framework where a UE can inform the base station (BS) about its preferred parameters. A UE can leverage local information and request configurations that can achieve satisfactory QoS while reducing power consumption if possible. For example, a UE may request to increase the bandwidth during the buffering stage of video streaming and to reduce the bandwidth when the video is not buffering.

### SUMMARY

The present disclosure relates to wireless communication systems and, more specifically, the present disclosure relates to a method and apparatus for UE power and QoS management using AI.

In one embodiment, a method includes determining a preferred configuration of a user equipment (UE) based on side information about the UE. The method also includes sending the preferred configuration of the UE to a base station via a UE assistance information (UAI) framework. The method further includes receiving a new configuration of the UE from the base station after the base station determines the new configuration based on the preferred configuration. The method also includes configuring the UE according to the new configuration.

In another embodiment, a UE includes a transceiver and a processor operably connected to the transceiver. The processor is configured to: determine a preferred configuration of the UE based on side information about the UE; send the preferred configuration of the UE to a base station via a UAI framework; receive a new configuration of the UE from the base station after the base station determines the new configuration based on the preferred configuration; and configure the UE according to the new configuration.

In yet another embodiment, a non-transitory computer readable medium includes program code that, when executed by a processor of a device, causes the device to: determine a preferred configuration of a UE based on side information about the UE; send the preferred configuration of the UE to a base station via a UAI framework; receive a new configuration of the UE from the base station after the base station determines the new configuration based on the preferred configuration; and configure the UE according to the new configuration.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example process for UE power and QoS optimization using AI according to embodiments of the present disclosure;

FIG. 5 illustrates an example traffic forecasting module for predicting network traffic using AI according to embodiments of the present disclosure;

FIG. 6 illustrates an example channel condition prediction module for predicting network channel conditions using AI according to embodiments of the present disclosure;

FIG. 7 illustrates an example process for QoS estimation according to embodiments of the present disclosure;

FIG. 8A illustrates further details of an example implementation of the QoS estimation module of FIG. 7 according to embodiments of the present disclosure;

FIG. 8B illustrates an example architecture of the QoS estimation module of FIG. 7 with separate traffic and throughput embedding extracting modules according to embodiments of the present disclosure;

FIG. 8C illustrates an example architecture of the QoS estimation module of FIG. 7 with joint traffic and throughput embedding extracting modules according to embodiments of the present disclosure;

FIGS. 8D and 8E illustrate example architectures of the QoS estimation module of FIG. 7 with vector traffic and throughput prediction inputs according to embodiments of the present disclosure;

FIG. 9 illustrates an example process for power consumption estimation according to embodiments of the present disclosure;

FIG. 10A illustrates further details of an example implementation of the power consumption estimation module of FIG. 9 according to embodiments of the present disclosure;

FIG. 10B illustrates an example architecture of the power consumption estimation module of FIG. 9 with separate traffic and throughput embedding extracting modules according to embodiments of the present disclosure;

FIG. 10C illustrates an example architecture of the power consumption estimation module of FIG. 9 with joint traffic and throughput embedding extracting modules according to embodiments of the present disclosure;

FIGS. 10D and 10E illustrate example architectures of the power consumption estimation module of FIG. 9 with vector traffic and throughput prediction inputs according to embodiments of the present disclosure;

FIG. 10F illustrates an example architecture of a joint QoS and power consumption estimation neural network model according to embodiments of the present disclosure;

FIGS. 11 and 12 illustrate example processes for configuration adaptation according to embodiments of the present disclosure; and

FIG. 13 illustrates a method for UE power and QoS management using AI according to embodiments of the present disclosure.

### DETAILED DESCRIPTION

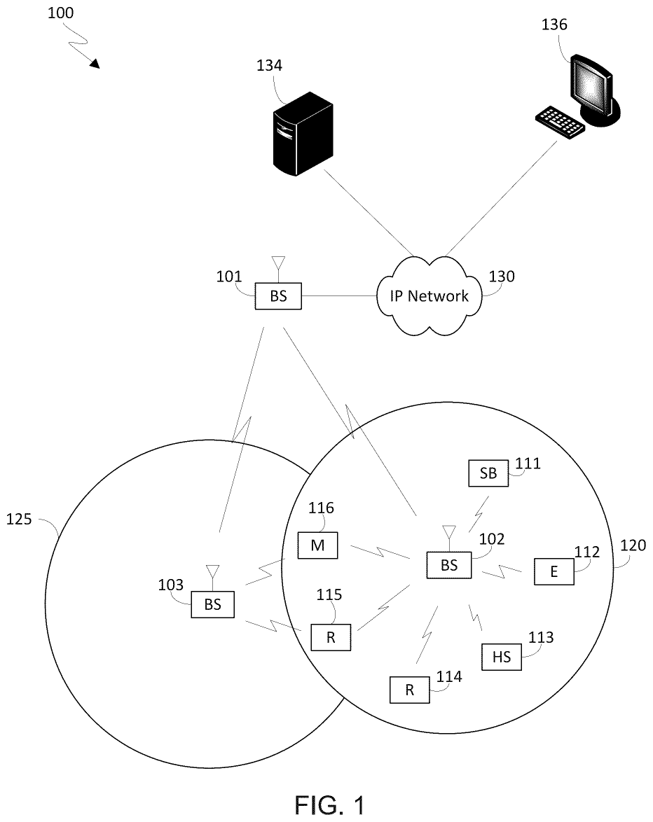

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

In some embodiments, the network 130 facilitates communications between at least one server 134 and various client devices, such as a client device 136. The server 134 includes any suitable computing or processing device that can provide computing services for one or more client devices. The server 134 could, for example, include one or more processing devices, one or more memories storing instructions and data, and one or more network interfaces facilitating communication over the network 130.

The client device 136 represents any suitable computing or processing device that interacts with at least one server or other computing device(s) over the network 130. In this example, the client device is represented as a desktop computer, but other examples of client devices can include a mobile telephone, laptop computer, or tablet computer. However, any other or additional client devices could be used in the wireless network 100.

In this example, client devices can communicate indirectly with the network 130. For example, some client devices can communicate via one or more base stations, such as cellular base stations or eNodeBs. Also, client devices can communicate via one or more wireless access points (not shown), such as IEEE 802.11 wireless access points. Note that these are for illustration only and that each client device 136 could communicate directly with the network 130 or indirectly with the network 130 via any suitable intermediate device(s) or network(s).

As described in more detail below, a computing device, such as the server 134 or the client device 136, may perform operations in connection with UE power and QoS optimization using AI.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

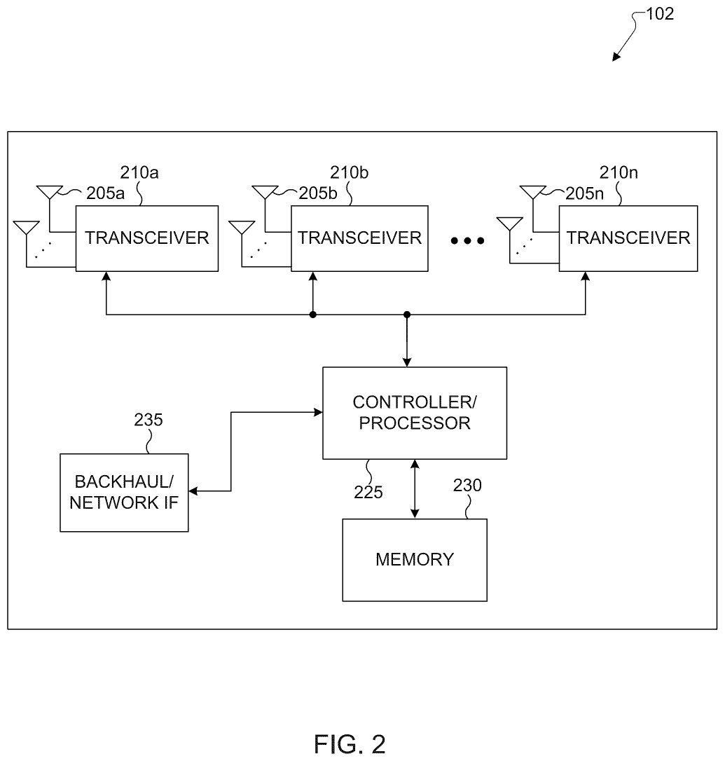

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support UE power and QoS optimization using AI as discussed herein. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

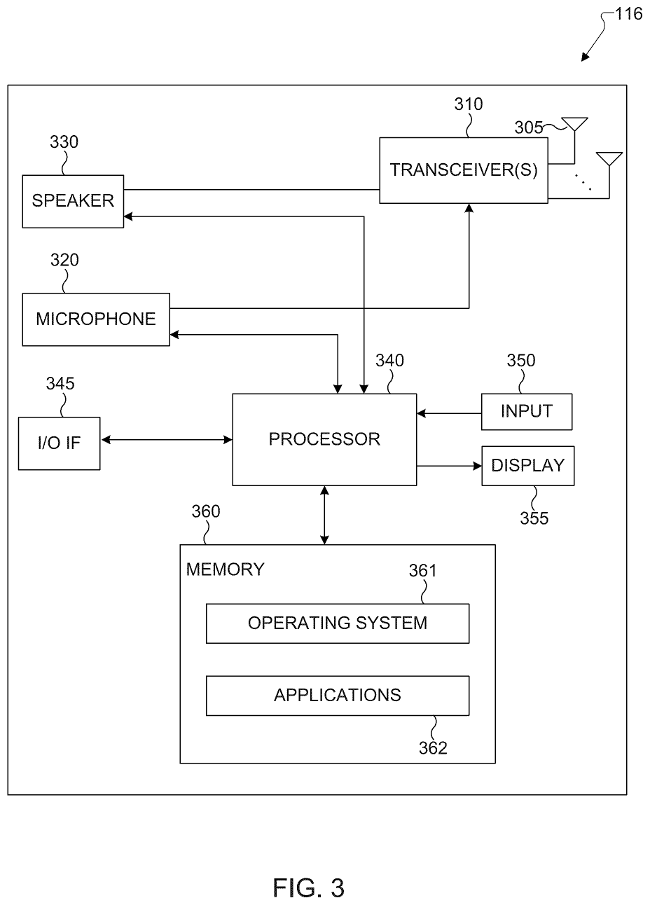

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for UE power and QoS optimization using AI. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 (which includes for example, a touchscreen, keypad, etc.) and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

As discussed above, the increase in power consumption resulting from various 5G applications and techniques is particularly challenging for UEs that rely on battery power. For example, the UE's radio frequency (RF) module is an important source of power consumption. In particular, higher bandwidth, larger number of multiple-input multiple output (MIMO) layers, and longer duty cycle lead to higher power consumption.

In an effort to overcome this challenge, 3GPP introduced the UE Assistance Information (UAI) framework in Rel. 16 of 5G, which allows the UE to report its preferred configuration to the BS. A UE can leverage local information and request configurations that can achieve satisfactory QoS while reducing power consumption if possible. For example, a UE may request to increase the bandwidth during the buffering stage of video streaming and to reduce the bandwidth when the video is not buffering. However, even with the UAI framework, the conventional techniques for UE configuration are static, QoS-agnostic, and lead to unnecessary power consumption.

To address these and other issues, this disclosure provides systems and methods for UE power and QoS optimization using AI. The disclosed embodiments enable the UE to dynamically adapt its 5G configuration based on various factors, including its data rate demand, its QoS requirement, and the throughput that the network can support. Given predictions of the traffic and the network capacity, the can UE estimate the QoS achieved by candidate configurations, and select the configuration that achieves maximum power saving while ensuring satisfactory QoS. The UE can then request the selected configuration through the UAI framework.

The disclosed embodiments feature application-specific and fast real-time dynamic adaptation of UE cellular configurations based on QoS and power consumption predictions. The disclosed embodiments also feature configuration-specific QoS estimation and power consumption estimation based on traffic forecast and channel condition prediction. In addition, the disclosed embodiments feature AI-based traffic forecasting and channel condition prediction. Some of the embodiments discussed below are described in the context of mmWave bands. Of course, these are merely examples. It will be understood that the principles of this disclosure may be implemented in any number of other suitable contexts, systems, or frequency bands, such as 6G or even later releases which may use THz bands.

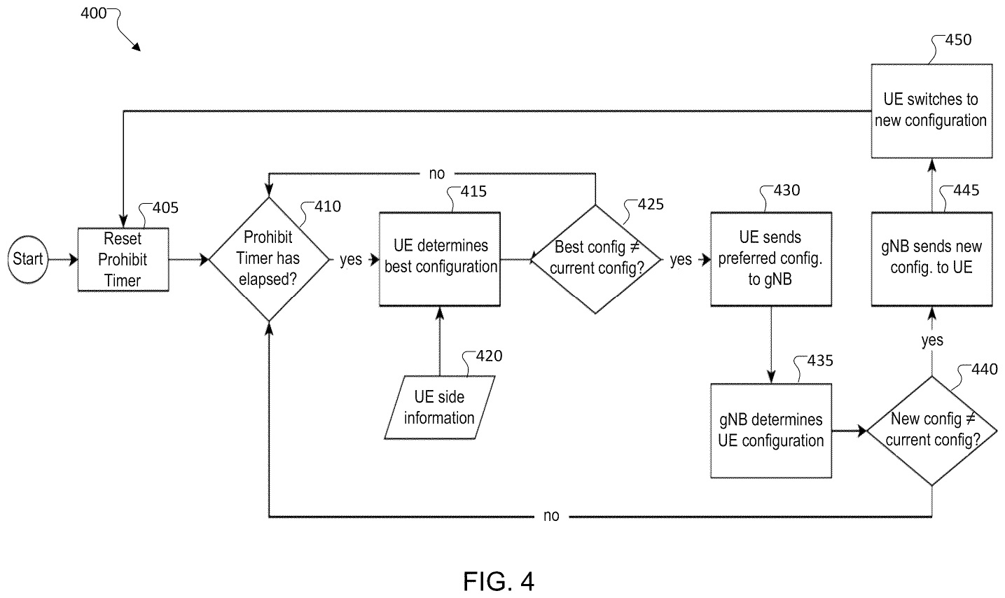

FIG. 4 illustrates an example process 400 for UE power and QoS optimization using AI according to embodiments of the present disclosure. In the process 400, the UE selects 5G configurations to reduce power consumption while ensuring QoS. For ease of explanation, the process 400 will be described as being implemented by the UE 116 and the gNB 102 of FIG. 1; however, the process 400 could be implemented by any other suitable device(s) or system(s). The embodiment of the process 400 shown in FIG. 4 is for illustration only. Other embodiments of the process 400 could be used without departing from the scope of this disclosure.

As shown in FIG. 4, the process 400 begins at operation 405. At operation 405, the UE 116 resets a prohibit timer. The prohibit timer is used by the UE 116 to prevent reconfiguration from occurring too frequently. When the elapsed time on the prohibit timer exceeds a predetermined threshold amount, another reconfiguration can occur. At operation 410, the UE 116 determines if the time from the previous configuration request has elapsed on the prohibit timer. If so, then the process 400 proceeds to operation 415, where the UE 116 uses one or more items of side information 420 (which is explained in greater detail below) to estimate the QoS and power consumption achievable by candidate 5G configurations in a short time horizon in the future. The UE 116 then selects a “best” (i.e., optimal) UE configuration, such as a configuration that minimizes the UE power consumption while achieving satisfactory QoS, or a configuration based on other selection metrics that consider the power consumption and QoS.

At operation 425, the UE 116 determines if the selected configuration is different than the current configuration. At operation 430, if the selected configuration is different than the current configuration, then the UE 116 sends the new configuration to the gNB 102 through UAI. At operation 435, the gNB 102 determines the UE configuration by accepting the requested configuration or modifying the configuration, or rejecting the request. At operation 440, it is determined if the new UE configuration is different than the current UE configuration. At operation 445, if the new UE configuration is different than the current one, then the gNB 102 sends the new configuration to the UE 116. In some embodiments, the gNB 102 can send the new configuration to the UE 116 through RRC or MAC-CE-based messaging. At operation 450, the UE 116 applies the new configuration and resets the prohibit timer upon receiving it. Alternatively, at operation 440, if the gNB 102 rejects the requested configuration from the UE 116 and decides to keep the current configuration, no further action is needed.

As described above, side information 420 available to the UE 116 can be used by the UE 116 to estimate the QoS and power consumption achievable by one or more candidate 5G configurations. The following side information 420 is assumed to be available to the UE 116:
The applications executing on the UE 116 and the QoS requirements of each application.
Predictions (forecasts) of the network traffic in the next T seconds.
Predictions of the throughput deliverable by the network in the next T seconds, based on predicted channel conditions in the network.
Additional information including internal status of application and sensor measurements on the UE 116.

The applications currently running on the UE 116 can be obtained from the operating system of the UE 116. The list of applications can be further refined to include only applications that are generating network traffic, such as by verifying the process ID and package name responsible for active sockets (e.g., through netstat on ANDROID). Alternatively, network traffic classification models, which take the IP packets (e.g., sequences of raw packet bits, packet header information, and timing information or their statistics) as input, can be used to predict the applications or services generating the traffic.

The QoS is application-specific. For instance, in International Telecommunication Union (ITU) P.1203, the mean opinion score (MOS) quantifies the QoS for video and audio users by considering the frame rate, encoding rate, and stalling behavior during video and audio streaming. The latency is another proxy for quantifying QoS. In 3GPP TS 23.501, the packet delay budget (PDB) specifies the 98th percentile latency of all TCP/IP packets required to achieve satisfactory QoS for different applications. Through the UAI framework specified in 3GPP Standard Release 16 (3GPP TS 38.331 V16.5.0), the UE 116 may report one or more of the following configurations that will impact both the power consumption and QoS of the UE 116:
Preferred connected mode discontinuous reception (CDRX) configuration
Preferred maximum aggregated bandwidth
Preferred maximum number of component carriers
Preferred maximum number of MIMO layers
Preferred scheduling offset for cross-slot scheduling

### Network Traffic Forecasting

As discussed above, one item of the side information 420 available to the UE 116, in order to determine a best configuration, is a forecast of network traffic in the next T seconds. In order to forecast the network traffic, the UE 116 can include a traffic forecasting module that predicts the amount of network traffic generated in the future by one or more active applications executing on the UE 116.

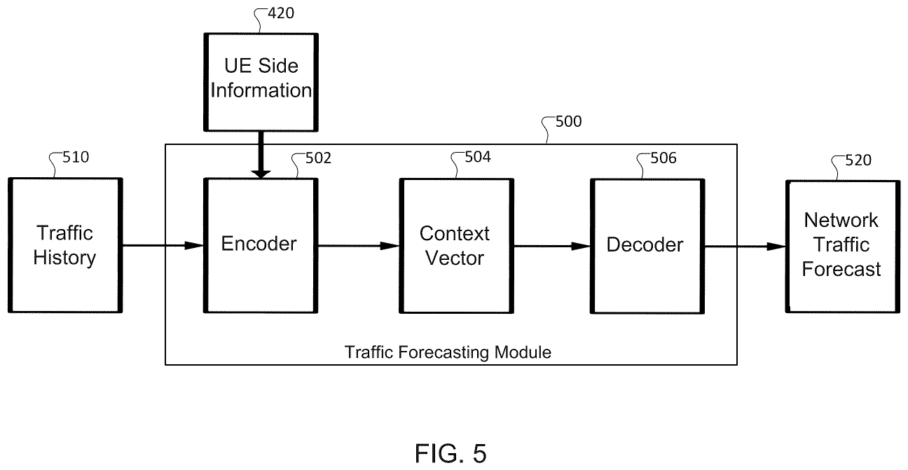

FIG. 5 illustrates an example traffic forecasting module 500 for predicting network traffic using AI according to embodiments of the present disclosure. For ease of explanation, the traffic forecasting module 500 will be described as being implemented as part of the UE 116 of FIG. 1; however, the traffic forecasting module 500 could be implemented by any other suitable device(s) or system(s). The embodiment of the traffic forecasting module 500 is for illustration only. Other embodiments of the traffic forecasting module 500 could be used without departing from the scope of this disclosure.

As shown in FIG. 5, the traffic forecasting module 500 receives traffic history 510 and the UE side information 420, and uses AI or machine learning to generate a network traffic forecast 520. In some embodiments, the network traffic forecast 520 is a prediction of network traffic, and can include a sequence of packet information, including the size, direction (UL or DL), and time stamp of each packet. The packet time can be represented as the time interval from the previous packet instead of absolute time stamps. If a single traffic forecasting module 500 is used to predict both DL and UL traffic, the network traffic forecast 520 can be a sequence in [symbol] ^{N×3}, where N is the number of predicted packets arriving in the future. Alternatively, individual traffic forecasting modules 500 may be used to predict DL and UL traffic respectively, where the output of each traffic forecasting module 500 is a sequence in [symbol] ^{N×2}. Lower prediction resolution may be achieved with alternative prediction output formulations. For example, in some embodiments, the traffic forecasting module 500 outputs the number of packets and the total packet size for every t₁ seconds in the DL and UL. The output may be two matrices in [symbol] ^{N}^{_{T}}^{×2} for the DL and UL traffic, where

$${N}_{T} = \frac{T}{{t}_{1}} ,$$

T is the duration of the prediction time horizon, and t₁ is the length of the sampling time window. A smaller sampling window t₁ will provide higher resolution predictions. If a large sampling window is used, more packets will likely be present in each sampling window. Additional packet statistics, including the maximum, minimum, and variance of the packet sizes, can be helpful.

The network traffic forecast 520 can additionally or alternatively be in the form of data rate statistics rather than the exact sequence of packets. In some embodiments, the traffic forecasting module 500 may predict summary statistics of the traffic generated over the entire prediction time horizon instead of a sequence of predictions. The network traffic forecast 520 may include the average data rate, maximum, minimum, variance, skewness and Kurtosis of the data rate computed with some sampling window t₂<<T, the average, maximum, minimum, variance, skewness, and Kurtosis of the packet size and inter-packet arrival times (IAT), the number of bursts and the size and duration of each bursts. The network traffic forecast 520 can be a vector in [symbol] ^{M}, where M is the number of predicted statistics.

With finer details of traffic forecast, the traffic forecasting module 500 can provide more information and allow better estimation of QoS and power consumption, but may result in a higher degree of complexity in training. Predicting the exact sequence of future packets provides the most information at the finest level of detail, which allows the time-varying estimate of QoS metric and power consumption, e.g., the per-packet latency and the power consumption over time. Prediction of the higher-level statistics of the traffic—such as the average and peak data rate—may allow higher-level and rougher estimation of the QoS and power consumption, such as the 98th percentile latency, the session MOS and total power consumption.

The input to the traffic forecasting module 500 can include the traffic history 510 and the UE side information 420, which can include the active applications of the UE 116, and the status of each application. The traffic history 510 can be obtained by monitoring IP packets and extracting the packet header information. In some embodiments the traffic history 510 can be represented as a time series of packet information, including the packet direction (DL or UL), packet size, transport layer protocol (TCP or UDP), IAT, packet header information (traffic class field in IP header, CWR, PSH, URG flags in TCP header, etc.), or a combination of these. Alternatively, the traffic history 510 can be represented as a time series summarizing the packet information in Nᵢₙ sampling windows each lasting tᵢₙ seconds. Here, the packet information can include the total number of packets, the number of DL and UL packets, the average, maximum, minimum, variance, skewness, and Kurtosis of packet size and IAT of DL packets, UL packets or all packets, the number of TCP and UDP packets, the number of TCP packets with CWR, PSH or URG flags, or a combination of these.

The status of each application can be explicitly provided by the operating system (OS) or the application, or can be inferred from user activity measurements such as the frequency of touchscreen interactions, accelerometer measurements, and gyroscope measurements. The application status information may include the buffer status of media streaming applications, the framerate, encoding rate and resolution of video being streamed, and the game state of gaming applications (such as loading, idle, play, pause, etc.). The traffic forecasting module 500 may use the active application and the application status as prior information for more accurate predictions. In some embodiments, a separate traffic forecasting module 500 can be trained for applications exhibiting different traffic patterns, e.g., consistent or bursty traffic. The application internal status can be used as an additional input. For instance, there will likely be a burst of packets due to buffering when the video buffer is low.

As discussed above, the traffic forecasting module 500 uses AI or machine learning techniques to generate the network traffic forecast 520. As shown in FIG. 5, the traffic forecasting module 500 can include an encoder 502, which extracts a context vector 504 from the input data that characterizes the previous traffic and user activity pattern, and a decoder 506, which then predicts the future traffic based on the context vector 504. The context vector 504 can include human-engineered features such as the summary statistics of IP traffic, including the total packet size, the number of UL and DL packets, and the average, maximum, minimum, variance, skewness, and Kurtosis of the size and IAT of the DL and UL packets.

In some embodiments, the encoder 502 can be a machine learning (ML) model that learns to extract the relevant context vector through training. The IP traffic module in the encoder 502 that processes the time-series IP traffic data can be, for example, a long short-term memory (LSTM), gated recurrent unit (GRU) module, or transformer neural network, which can take both fixed and variable length sequences as the input. Alternative neural network architectures, such as fully-connected neural network or convolutional neural network (CNN), can be used if the input sequence has a fixed length such as by specifying a fixed number of previous packets or a fixed number of sampling windows Nᵢₙ. The application type and application status feature can be combined with the output of the IP traffic module—such as by concatenation—and passed into a fusion module—such as a fully-connected neural network—to obtain the final context vector 504.

If the desired network traffic forecast 520 is a sequence of predictions, the decoder 506 can be implemented as a sequence-to-sequence model such as a LSTM, GRU, or transformer neural network. The decoder 506 takes the context vector 504 as input and generates the first predicted output, such as the size, direction, and IAT of the next packet or traffic statistics in the next sampling window. The output can be fed back into the encoder 502 to generate the updated context vector 504, which is passed into the decoder 506 to generate the subsequent prediction. This process can be iterated until the desired prediction horizon is reached. To predict future packets over a T-second future horizon, the traffic forecasting module 500 may iteratively predict packets until the total IAT exceeds T seconds. Alternatively, the packets can be represented as the number of packets and total packet sizes computed in a time window of t₁ seconds over a time horizon of T seconds, resulting in length-T/t₁ sequences as the output of the data rate prediction module.

If the desired network traffic forecast 520 is a summary of the traffic over the entire prediction horizon, the decoder 506 can be any suitable feed-forward neural network that outputs a predicted vector containing the traffic statistics using the context vector 504 as its input. Alternatively, a recurrent or transformer neural network may be used, which outputs the predicted traffic statistics after the latest input sample is fed in.

The encoder 502 and the decoder 506 can be trained in an end-to-end fashion. Traffic forecasting can be formulated as a regression problem and the traffic forecasting module 500 can be trained with supervised learning. The labels are the true sequence of future IP traffic or summary statistics of future traffic. The traffic forecasting module 500 can be trained with supervised learning, where the input is the history sequence of packet size and interarrival times, and the output is the sequence of predicted packet size and interarrival times for packets arriving in the future. The training data can include traces of IP packet size and time stamps and the status of the application when applicable. The input features and output labels—time series or overall summary of traffic information—can be computed from the IP packet traces. The encoder 502 and the decoder 506 may be trained to minimize regression loss functions such as the mean squared error (MSE) or the mean absolute error (MAE).

### Channel Condition Prediction

As discussed above, another item of the side information 420 available to the UE 116, in order to determine a best configuration, is one or more predicted channel conditions in the network. In order to predict channel conditions in the network, the UE 116 can include a channel condition prediction module that predicts the amount of network traffic generated in the future by one or more active applications executing on the UE 116.

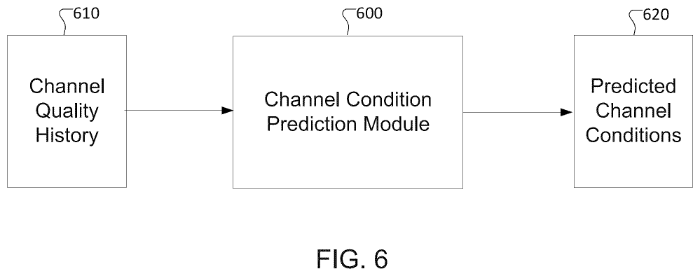

FIG. 6 illustrates an example channel condition prediction module 600 for predicting network channel conditions using AI according to embodiments of the present disclosure. For ease of explanation, the channel condition prediction module 600 will be described as being implemented as part of the UE 116 of FIG. 1; however, the channel condition prediction module 600 could be implemented by any other suitable device(s) or system(s). The embodiment of the channel condition prediction module 600 is for illustration only. Other embodiments of the traffic channel condition prediction module 600 could be used without departing from the scope of this disclosure.

As shown in FIG. 6, the channel condition prediction module 600 takes channel quality history 610 as input. The channel quality history 610 is history of channel quality measurements, which can include the CQI, RI, RSRP, RSRQ, SINR, allocated MCS, and the fraction of resource blocks allocated to the UE 116. Such measurements are obtained at a fixed time interval t₃ and can be represented as a time series, where each sample is a vector in [symbol] ^{K} and K is the number of measured quantities. The input feature to the channel condition prediction module 600 is a matrix in [symbol] ^{N}^{_{CSI}}^{×K}, where N^{CSI} is the number of previous measurements to use. Additional information such as the location and trajectory of the UE 116 can also be used. For instance, the UE 116 will likely experience worse throughput when entering areas with bad cellular coverage.

In one embodiment, the channel condition prediction module 600 outputs a sequence of predicted channel conditions 620 in the future such as the SINR, the RI and the MCS. To generate the predicted channel conditions 620 over a future time horizon with duration T, the prediction output has ┌ T/t₃┐samples and is a matrix in

$${ℝ}^{⌈ \frac{T}{{t}_{3}} ⌉ \times L} ,$$

where L is the number of predicted quantities. In some embodiments, the channel condition prediction module 600 can have an encoder-decoder architecture similar to that of the traffic forecasting module 500. In some embodiments, the channel condition prediction module 600 can be implemented as a sequence-to-sequence prediction model, such as an LSTM, GRU or transformer neural network. Each sample in the input sequence is iteratively fed into the neural network, which outputs the first prediction after processing the latest sample. Its outputs are then fed back as the inputs to iteratively generate subsequent predictions. Both the inputs and the labels are channel condition measurements directly obtained from training data. Predicting a sequence of future channel conditions provides higher resolution and allow better estimation of QoS and power consumption. It can be important to capture variations in the channel condition since bad channel conditions will likely be the bottleneck for QoS. On the other hand, such models tend to be more complex to train.

In other embodiments, the predicted channel conditions 620 can be represented as a single vector containing the summary information of channel conditions in the next T seconds, such as the average, minimum, and variance of SINR and MCS. The channel condition prediction module 600 can be implemented as a recurrent or transformer neural network, but only outputs a single sample representing the prediction for the entire future T seconds. The channel condition prediction module 600 may also be implemented as any feed-forward neural network or ML model. The input is the sequence or matrix of previous channel condition measurements, and the label is the summary statistics computed based on the channel condition in the next T seconds. In general, such models tend to be less difficult to train but provide less information compared to the sequence-to-sequence models.

The channel condition prediction module 600 can be trained with supervised learning. If the predicted quantity is the SINR, channel condition prediction may be formulated as a regression problem and loss functions such as MSE can be chosen. If the predicted quantity is the MCS and RI, channel condition prediction may be formulated as a classification problem and the cross-entropy loss function may be chosen. Alternatively, the channel condition prediction module 600 may be trained as one or more regression models to predict the MCS and RI as continuous values and quantize afterwards.

### QoS Estimation

The network traffic forecast 520 and the predicted channel conditions 620 can be used by the UE 116 to estimate the future QoS and power consumption for a given configuration of the UE 116. A process for QoS estimation will now be described.

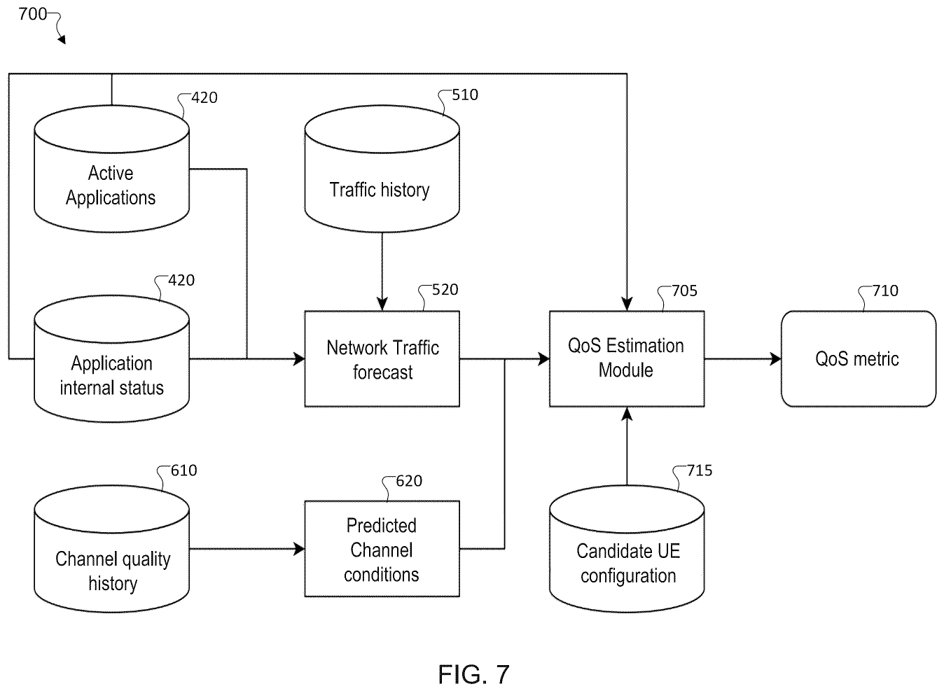

FIG. 7 illustrates an example process 700 for QoS estimation according to embodiments of the present disclosure. For ease of explanation, the process 700 will be described as being implemented using the UE 116 of FIG. 1; however, the process 700 could be implemented by any other suitable device(s) or system(s). The embodiment of the process 700 is for illustration only. Other embodiments of the process 700 could be used without departing from the scope of this disclosure.

As shown in FIG. 7, the process 700 uses a QoS estimation module 705 executed by the UE 116 that estimates QoS to determine a QoS metric 710. In the process 700, the QoS estimation can be based on direct measure of the QoS of the UE 116, such as the MOS. Alternatively, the QoS estimation can be based on proxy metrics that indirectly reflect the UE's QoS, such as the 98th percentile latency and the user experienced throughput. The QoS estimation module 705 can include one or more ML regression models that obtain the network traffic forecast 520, the predicted channel conditions 620, and one or more candidate UE configurations 715 as inputs, and output the QoS metric 710.

The QoS depends on the throughput deliverable by the gNB 102, which is a function of the channel condition, the UE's configuration, the gNB resource allocation policy, and the network load. The throughput can be explicitly inferred from the predicted channel conditions 620 and the candidate UE configurations 715, such as by computing the spectral efficiency using predicted SINR and scaling by the configured bandwidth B in Equation (1) below, or computing the modulation order Q and coding rate R from the predicted MCS and scaling by the number of MIMO layers L and the number of resource blocks NPRB in Equation (2) below. The number of resource blocks may depend on the network load and can also be predicted instead of using a fixed value. In Equation (2), Tₛ is the OFDM symbol duration and OH is the control channel overhead.

$$Tput = ( RI + 1 ) \times B \times log ( 1 + SINR ) \qquad ( 1 )$$

$$Tput = L \times Q \times R \times \frac{{N}_{PRB} \times 12}{{T}_{s}} \times ( 1 - OH ) \qquad ( 2 )$$

Alternatively, the candidate UE configurations 715 may be used as an additional input to the QoS estimation module 705 instead of explicitly using it to compute the throughput.

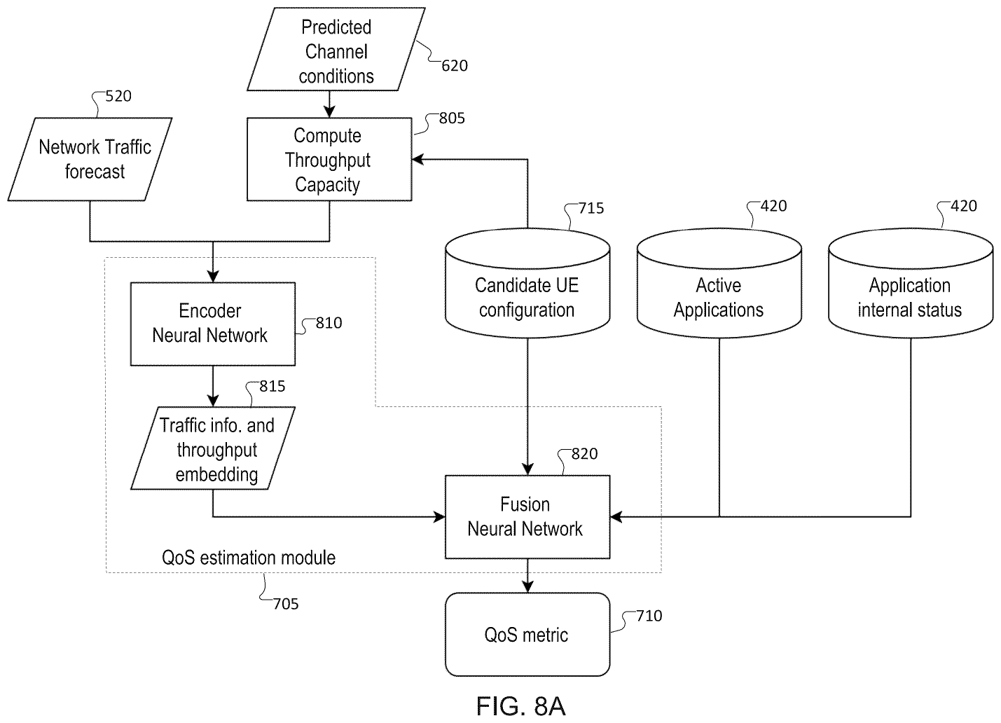

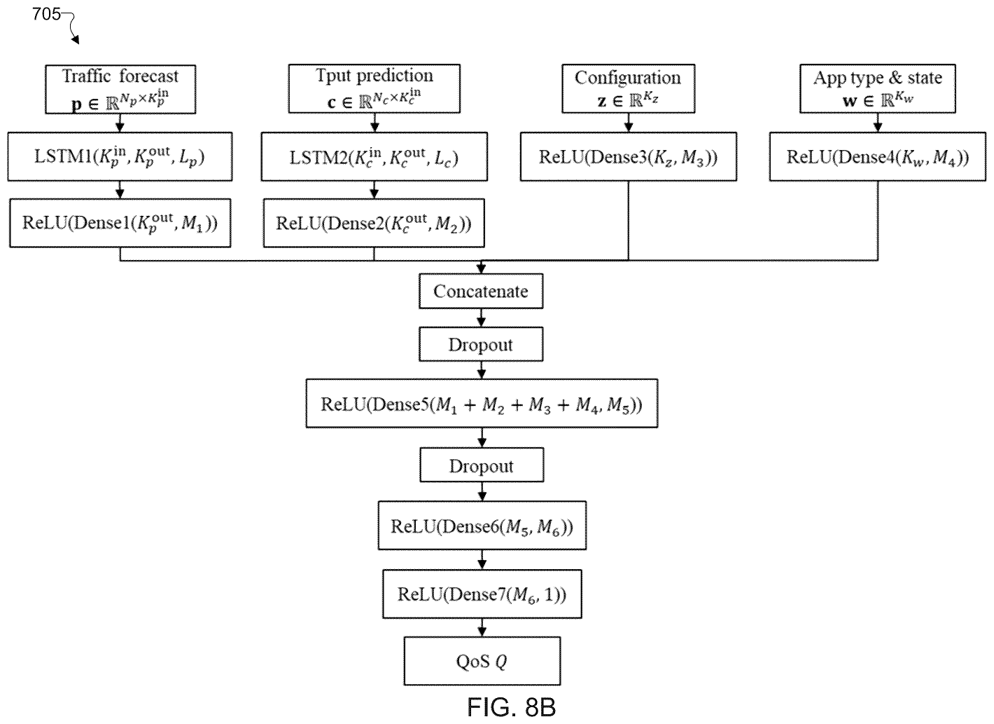

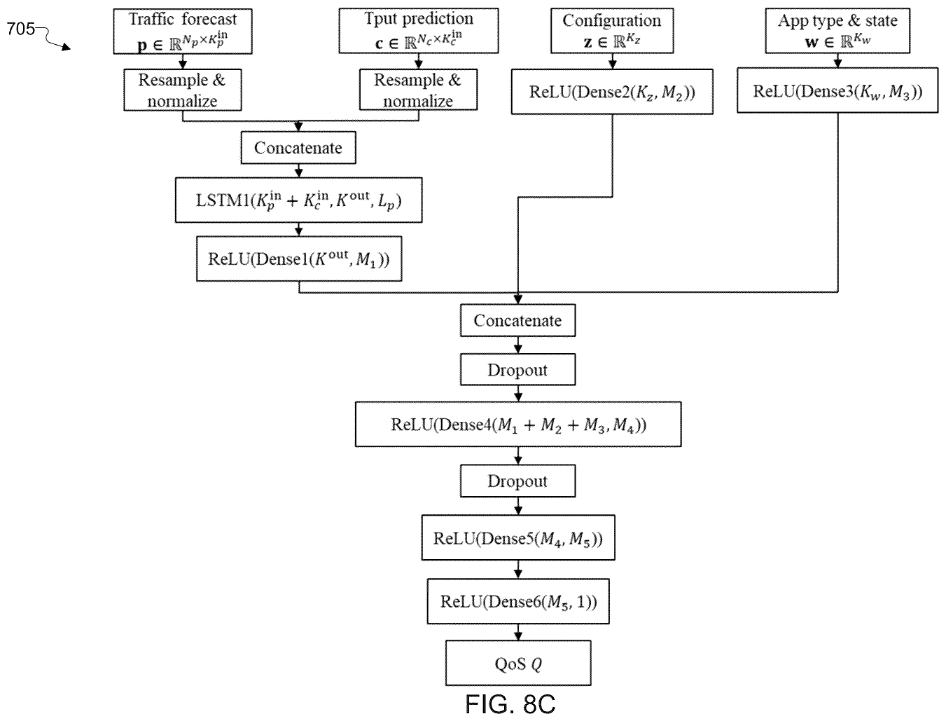

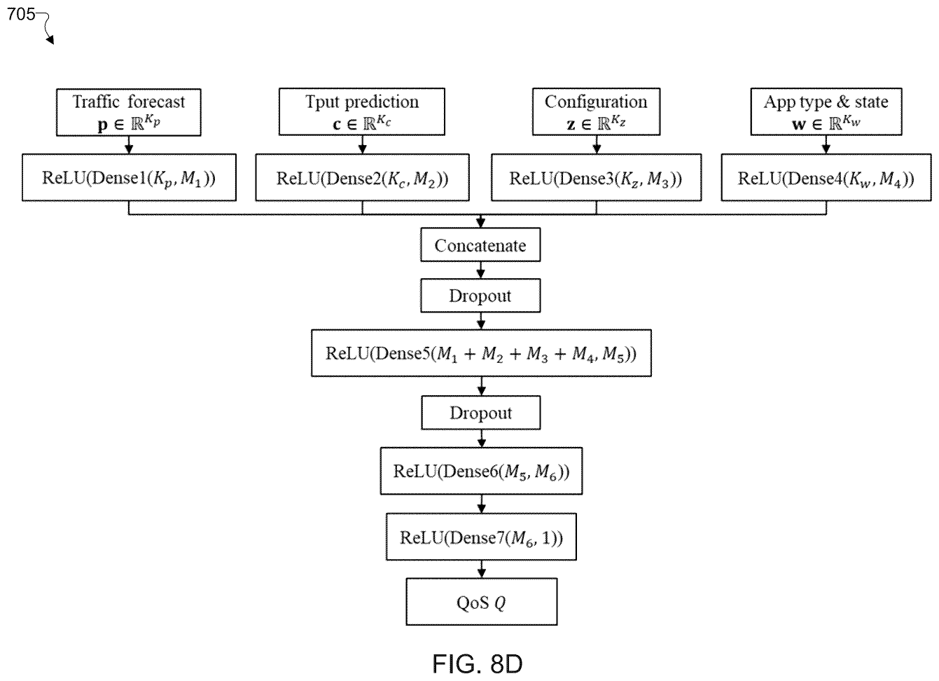

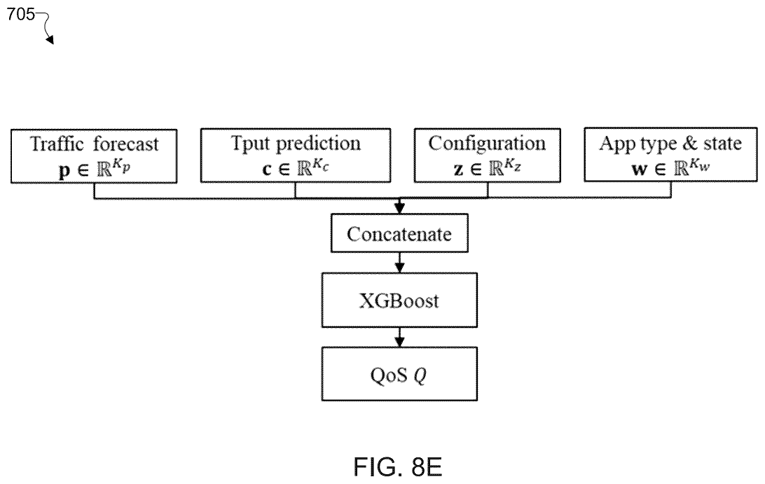

FIG. 8A illustrates further details of an example implementation of the QoS estimation module 705 according to embodiments of the present disclosure. In some embodiments, the channel condition prediction module 600 outputs a sequence of predicted channel conditions 620 and the traffic forecasting module 500 outputs a sequence of network traffic forecasts 520. As shown in FIG. 8A, for a given configuration, the throughput capacity 805 (which can also be a sequence) can be computed from the predicted channel conditions 620 based on Equation (1) or Equation (2). In this situation, the inputs to the QoS estimation module 705 are the sequences of network traffic forecasts 520 and the throughput capacity 805. The output is the QoS metric 710, such as MOS or 98th percentile latency. The QoS estimation module 705 can be a recurrent or transformer neural network, which iteratively takes samples from the input and outputs an embedding vector after the latest input sample is processed.

In some embodiments, the throughput capacity 805 and the network traffic forecasts 520 can be processed by a single model. The two sequences may need to be over-sampled or sub-sampled accordingly so that they have the same length. For instance, if the network traffic forecast 520 is a sequence of future packets, the sequence of predicted channel conditions 620 may be sampled to contain the channel condition corresponding to the arrival time of the packets. If the sequence of network traffic forecasts 520 is based on traffic information in small sampling windows, the sequence of predicted channel conditions 620 may be sampled to match the sampling window duration. The throughput capacity 805 and sequence of network traffic forecasts 520 may be concatenated as a single length-N_{Qos,in} sequence as processed by the QoS estimation module 705. The throughput capacity 805 and the network traffic forecasts 520 may also be processed by two separate neural networks, each outputting a vector embedding from the input sequence, which are then concatenated and processed by the QoS estimation module 705 to produce the final QoS metric 710.

As shown in FIG. 8A, the QoS estimation module 705 includes an encoder neural network 810 that receives the throughput capacity 805 and the network traffic forecasts 520 as input, and outputs an embedding vector 815 that reflects the throughput capacity 805 and the network traffic forecasts 520. The encoder neural network 810 can be a RNN or transformer neural network, or any other suitable neural network. A fusion neural network 820 receives and processes the embedding vector 815 to generate the final QoS metric 710.

Alternatively, the QoS estimation module 705 can be any feed-forward neural network that processes the sequences as matrices to output the estimation. If the channel condition prediction and traffic forecast are processed by a single QoS estimation module 705, the QoS estimation module 705 can also be a traditional ML regression model such as XGBoost. The application information is used as additional features, e.g., as one-hot vectors encoding the application type and application state (video streaming & buffering, video streaming & steady state, cloud gaming & loading, cloud gaming & active playing, etc.). The application information feature may be combined with the embedding generated from the channel condition and traffic predictions and passed through a neural network fusion module (such as a fully-connected neural network) to generate the QoS metric 710.

In other embodiments, the channel condition prediction module 600 and the traffic forecasting module 500 each output the summary statistics of future channel condition and traffic information. The predicted channel condition, traffic information and application information (if applicable) can be combined (such as by concatenation) to form a single feature vector for the QoS estimation module 705. The QoS estimation module 705 can be any feed-forward neural network or traditional ML regression model.

In some embodiments, the channel condition prediction module 600 may output a sequence while the traffic forecasting module 500 outputs the summary statistics—or vice versa. An embedding vector is generated for each input modality: through RNN, transformer or feed-forward neural network for sequence input and feed-forward neural network for summary statistics input. The embedding vectors are then combined and passed into a fusion neural network module to generate the final QoS metric 710.

The application status may also be used as prior information instead of as a part of the features. For instance, a different QoS estimation module 705 may be trained for each application type and state such as video streaming, video call, audio call, active playing during cloud gaming.

An example neural network architecture for the QoS estimation module 705 is shown in FIG. 8B. The network traffic forecast 520 is represented as a length-Nₚ sequence where the feature dimension Kₚⁱⁿ depends on output from the traffic forecasting module 500. The throughput prediction is represented as a length-N_{c} sequence computed from channel conditions and the candidate UE configuration 715. The candidate UE configuration 715 is represented either as a real-valued vector where K^{z} is the number of parameters and each element is the value of the parameter, or as a one-hot or multi-hot encoded vector based on all possible configurations. The application type and state side information are represented as a one-hot/multi-hot encoded vector based on all possible app types and states. An LSTM module with parameters (Kⁱⁿ, K^{out}, L) takes Kⁱⁿ-dimensional inputs, K^{out} is the hidden state dimension, and L is the number of LSTM layers. The LSTM modules extract information from the network traffic forecast 520 or throughput predictions and generate an embedding vector for each modality. A dense layer with parameters (M₁,M₂) is a fully connected linear layer with M₁-dimensional input and M₂-dimensional output. A separate LSTM module is used to extract the embedding from the network traffic forecast 520 and the throughput prediction. The embedding from the four modalities are concatenated and passed through multiple dense layers to obtain the QoS estimate Q. Dropout can be used to reduce overfitting during training.

An alternative neural network architecture is shown in FIG. 8C. The sequences of traffic forecasts and throughput predictions are resampled and normalized to have the same length, then concatenated to form a single length-N sequence with (Kₚⁱⁿ+K_{c}ⁱⁿ)-dimensional features. The concatenated traffic and throughput predictions are processed by a single LSTM module.

In some embodiments, the network traffic forecast 520 and throughput prediction are represented as Kₚ and K_{c}-dimensional vectors containing the summary statistics of the prediction. The four input modalities can be processed by a neural network as shown in FIG. 8D or concatenated to form the input feature to a ML regression model such as XGBoost, as shown in FIG. 8E.

In some embodiments, QoS estimation can be formulated as a regression problem. The QoS estimation module 705 can be trained through supervised learning, such as by minimizing the MSE between the predicted QoS and the actual QoS. The neural network weights can be learned through backpropagation by performing stochastic gradient descent (or its variants) on the loss function, such as by the following:

$${θ}^{*} = {min}_{θ} \frac{1}{n} {\sum }_{i = 1}^{n} {( f ( {x}_{i} \vert θ ) - {Q}_{i} )}^{2} ,$$

where ƒ(|θ) is the NN parameterized by θ, xᵢ in the input to the neural network in the ith sample, ƒ(xᵢ|θ) is the predicted QoS, and Qᵢ is the ground truth QoS metric for the ith sample.

If the target QoS metric is the latency, the labels can be obtained from real or simulated data. For real data collection, the user can execute a particular application while the UL and DL packets observed at the UE 116 as well as the throughput measurements are recorded, which are the input to the QoS estimation module 705. Additionally, the QoS metric 710, such as the latency or the MOS score, is recorded. The per-data-packet round-trip latency for TCP can be derived from the ACK packets. Alternatively, the UE 116 may periodically actively measure the latency through ICMP or application layer measurement messages. The MOS score can be evaluated by human subjects or computed according to parametric models. For instance, ITU P.1203 specifies a parametric model for QoS prediction based on parameters including the audio and video bit rate, video resolution frame rate and encoding rate, and stalling events. A parametric MOS model for cloud gaming is specified in ITU G.1072. A parametric MOS model for video call is specified in ITU G.1070 and J.148. The QoS estimation label for training can be the target statistics of the QoS metric, such as the MOS over T seconds or the 98th percentile latency.

### Power Consumption Estimation

Like the QoS estimation, power consumption estimation can be achieved with ML regression models that takes the data rate prediction, the channel condition prediction, and the configuration as input and outputs a prediction of the QoS or power consumption metric. Separate ML models can be used for QoS estimation and power consumption estimation, where the model output is a scalar representing the predicted metric. Alternatively, a combined model whose output is a vector containing both the QoS and power consumption metrics can be adopted. Like the QoS, the power consumption depends on the throughput deliverable by the gNB, which is a function of the channel condition, the UE's configuration, the gNB resource allocation policy, and the network load.

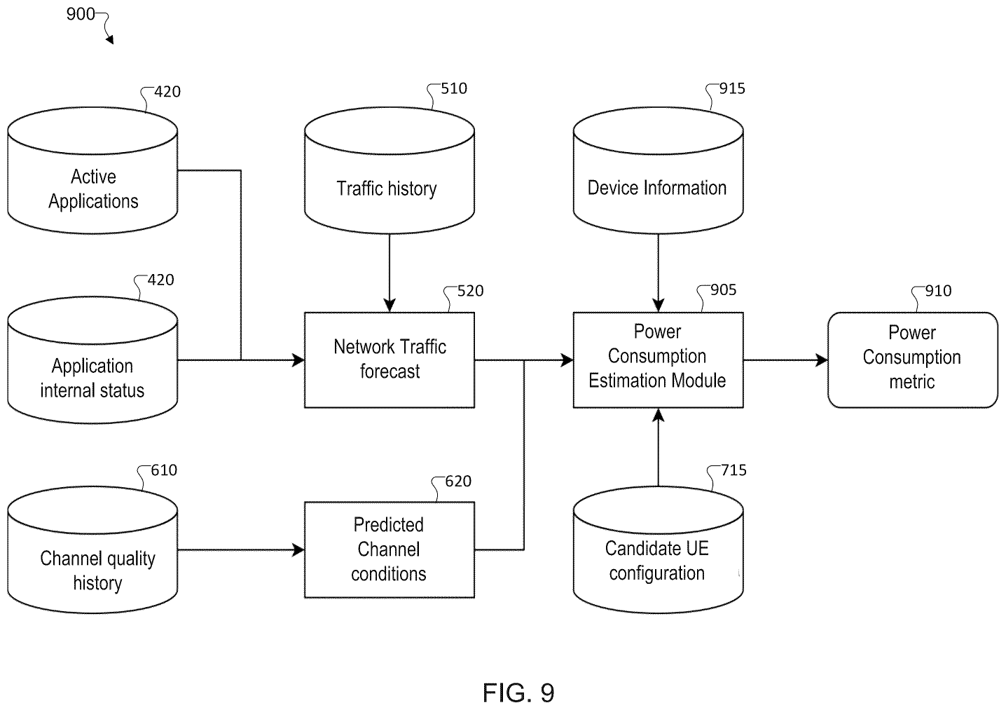

FIG. 9 illustrates an example process 900 for power consumption estimation according to embodiments of the present disclosure. For ease of explanation, the process 900 will be described as being implemented using the UE 116 of FIG. 1; however, the process 900 could be implemented by any other suitable device(s) or system(s). The embodiment of the process 900 is for illustration only. Other embodiments of the process 900 could be used without departing from the scope of this disclosure.

As shown in FIG. 9, the process 900 includes multiple components and operations that are the same as, or similar to, corresponding components and operations of the QoS estimation process 700 of FIG. 7. The process 900 uses a power consumption estimation module 905 that estimates power consumption to determine a power consumption metric 910, which can be, for example, an average or total power consumption over a time period T. Inputs to the power consumption estimation module 905 can include the network traffic forecast 520, the predicted channel conditions 620, the candidate UE configurations 715, and device information 915 over the time period T. The network traffic forecast 520, the predicted channel conditions 620, and the candidate UE configurations 715 can be processed with similar methods and neural network architectures used by the QoS estimation module 705 as described above. The device information 915 can include information such as the temperature of the chip.

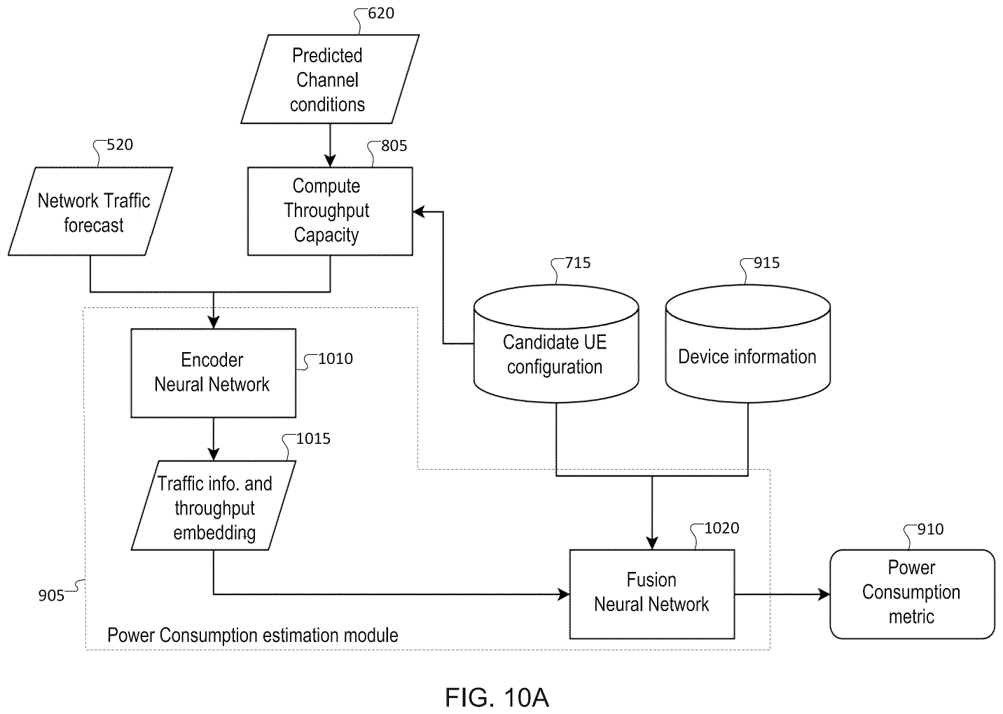

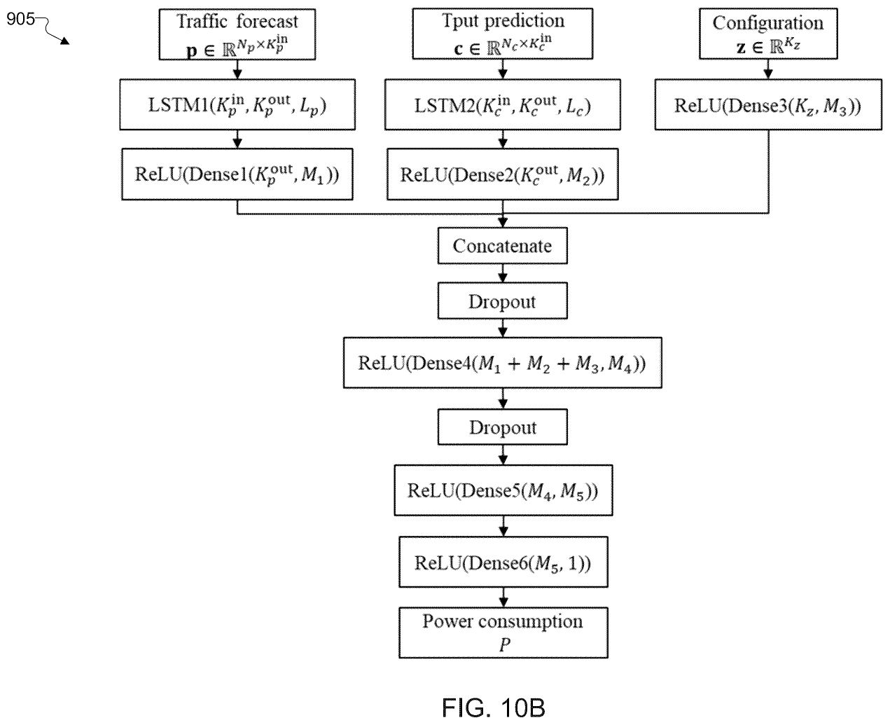

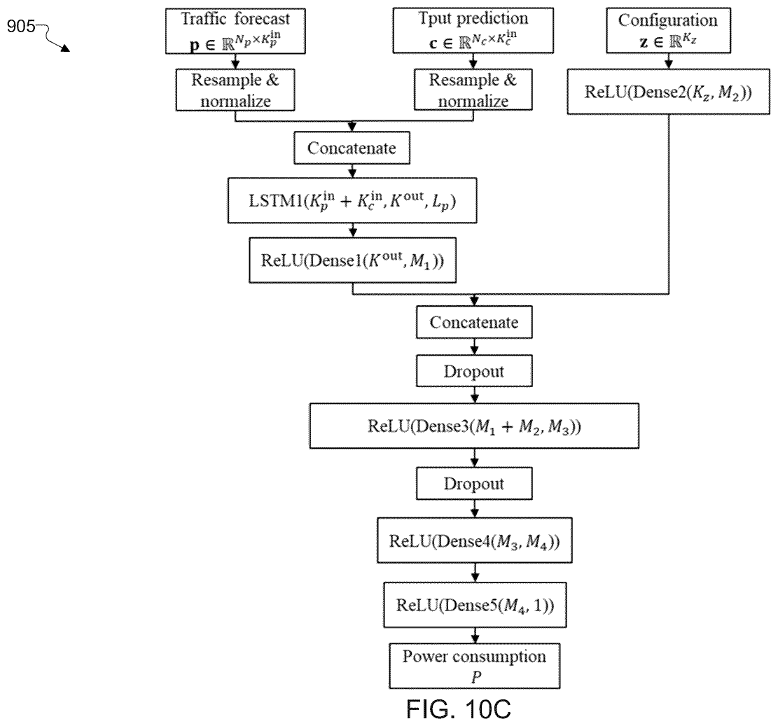

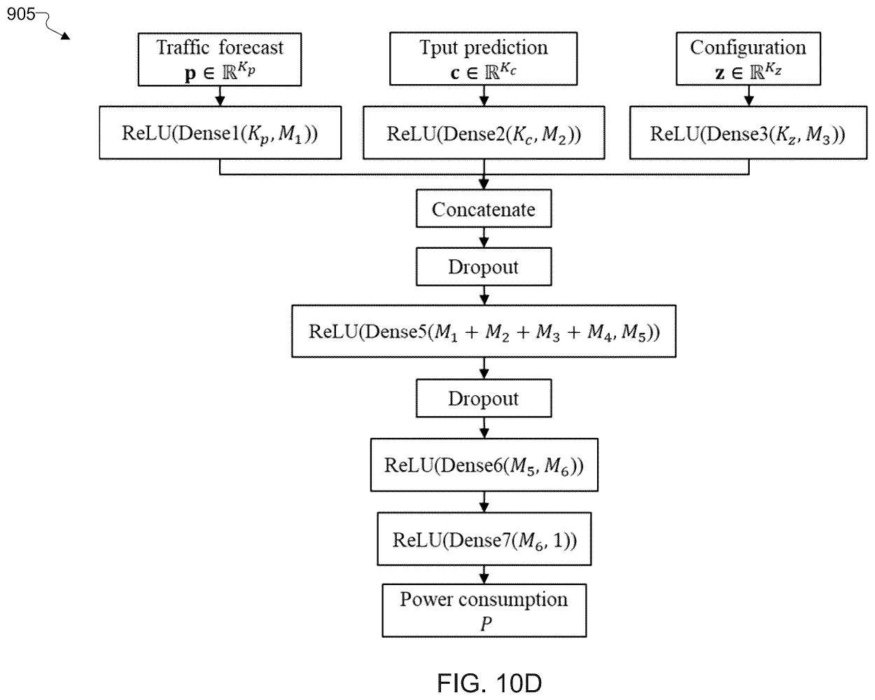

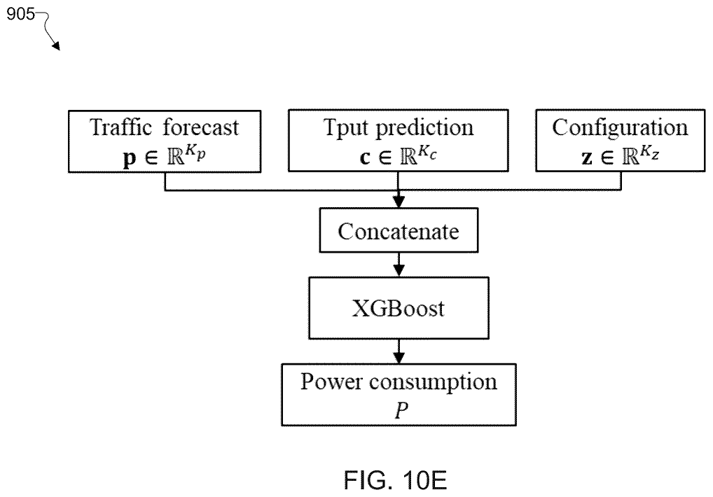

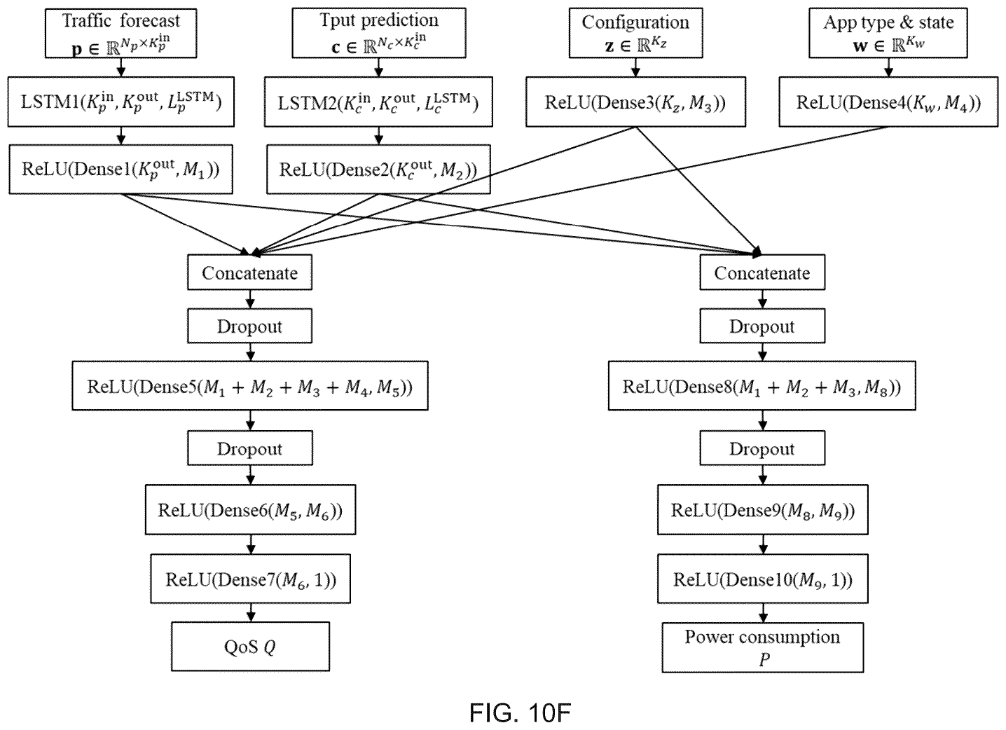

FIG. 10A illustrates further details of an example implementation of the power consumption estimation module 905 according to embodiments of the present disclosure. As shown in FIG. 10A, the power consumption estimation module 905 includes an encoder neural network 1010 that receives the throughput capacity 805 and the network traffic forecasts 520 as input, and outputs an embedding vector 1015 that reflects the throughput capacity 805 and the network traffic forecasts 520. The encoder neural network 1010 can be a RNN or transformer neural network, or any other suitable neural network. In some embodiments, the encoder neural network 1010 and the encoder neural network 810 of FIG. 8A represent a single shared encoder network. A fusion neural network 1020 receives and processes the embedding vector 1015 to generate the final power consumption metric 910. Similar to the QoS estimation module 705, the power consumption estimation module 905 can be trained through supervised learning by minimizing the MSE.

Training data for the power consumption estimation module 905 can be obtained from simulation or field data collection. To obtain simulated power consumption, a power state is assumed for each UE state in each slot depending on the PHY-layer activity—such as PDCCH monitoring, PDSCH transmission and Sleep—and the configuration is adopted. An example power state and configuration-dependent scaling law can be derived from 3GPP TR 38.840, which defines a power level for each UE state and a power scaling law according to the bandwidth, number of antennas, and number of CCs. Field measurements of power consumption can be obtained from operating system tools such as ANDROID battery historian and energy profiler. More detailed RF power consumption can be obtained from component power measurements. The power consumption estimation label for training can be the average power consumption over T seconds.

The power consumption estimation module 905 may employ similar architectures as the QoS estimation module 705 described above, except that the power consumption estimation module 905 can have three input modalities: traffic forecast, throughput prediction, and the configuration. As shown in FIG. 10B, the traffic forecast and throughput prediction sequential inputs are processed by LSTM modules to obtain their embedding vectors. The traffic and throughput prediction and configuration embedding vectors are concatenated to obtain the input vector to the prediction neural network module containing multiple dense layers with dropout to reduce overfitting. An alternative neural network architecture where the traffic and throughput predictions are resampled to the sample length, concatenated, and processed by a single LSTM module, is shown in FIG. 10C. If the traffic forecast and throughput prediction are vectors containing the summary statistics instead of sequences, they can be processed by a feed-forward neural network shown in FIG. 10D, or concatenated and processed by a ML model such as XGBoost as shown in FIG. 10E.

The power consumption estimation module 905 can be a regression model and be trained through supervised learning. If the model employs a neural network architecture, the neural network weights can be learned through backpropagation by running SGD minimizing the loss function. The loss function can be the MSE between the true and predicted power consumption:

$${φ}^{*} = {min}_{φ} \frac{1}{n} {\sum }_{i = 1}^{n} {( g ( {x}_{i} \vert φ ) - {P}_{i} )}^{2} ,$$

where g(|φ) is the neural network parameterized by φ, xᵢ in the input to the neural network in the ith sample, g(xᵢ|φ) is the predicted power consumption, and Pᵢ is the ground truth power consumption for the ith sample.

In some embodiments, the QoS estimation module 705 and the power consumption estimation module 905 share weights for embedding extraction modules (LSTM1, LSTM2, Dense1, Dense2, Dense3, Dense4), but employ separate subsequent prediction modules to output the QoS and power consumption estimates, as shown in FIG. 10F.

### Configuration Adaptation

As discussed above, the candidate UE configurations 715 are used in the QoS estimation process 700 and power consumption estimation process 900. The QoS estimation module 705 and the power consumption estimation module 905 estimate the QoS metric 710 and the power consumption metric 910 for all candidate UE configurations 715 given the data rate and channel condition prediction over the next T seconds. A set of feasible configuration parameters is determined by the parameters supported by the UAI framework and their possible values, which can be obtained from 3GPP TS 38.331. An example set of parameters and their candidate values are shown in Table 1 below. The set of candidate UE configurations 715 may include all possible parameter choices, or can be narrowed down to contain a subset to reduce the search complexity. For instance, the maximum number of MIMO layers may be limited by the UE device capability and the maximum bandwidth may be limited by the gNB band. Candidate CDRX cycle duration and inactivity timer may be sampled from the list of possible values in 3GPP TS 38.331 to reduce the resolution.

TABLE 1
Example of parameters to configure and their candidate values.

| Parameter | Candidate Values |
|---|---|
| DL bandwidth (MHz) | 20, 40, 60, 80, 100 |
| UL bandwidth (MHz) | 20, 40, 60, 80, 100 |
| DL MIMO layers | 1, 2, 4 |
| UL MIMO layers | 1, 2, 4 |
| Max CCs | 0, 1, 2 |
| DRX long cycle (ms) | 20, 40, 80, 160, 320, 1280 |
| DRX short cycle (ms) | 2, 4, 8, 16, 32, 64 |
| DRX inactivity timer (ms) | 10, 20, 40, 80, 100 |

Instead of performing an exhaustive search over all candidate UE configurations 715, the search space may be adapted dynamically based on the current configuration and by comparing the current and future channel conditions and traffic requirements. By default, the set of candidate UE configurations 715 includes all possible configurations. Assuming the current configuration is able to satisfy the QoS requirement, if the predicted channel is worse and/or the predicted traffic is heavier, the set of candidate UE configurations 715 may be reduced to contain only those that tend to result in higher QoS compared to the current configuration, such as those with a larger bandwidth, a larger maximum number of MIMO layers, shorter CDRX cycle duration, and longer CDRX inactivity timer. On the other hand, if the predicted channel is better and the predicted traffic is lighter, the set of candidate UE configurations 715 may be reduced to contain only those that tend to consume less power compared to the current configuration. Dynamically adapting the set of candidate UE configurations 715 may result in suboptimal configuration choices but reduces the search complexity.

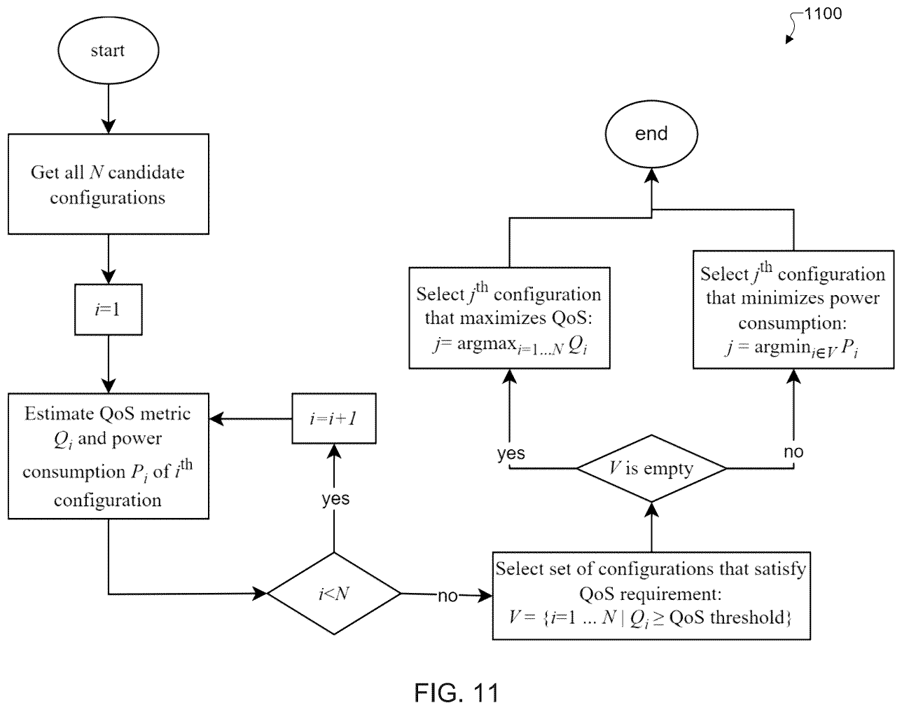

FIG. 11 illustrates an example process 1100 for configuration adaptation according to embodiments of the present disclosure. As shown in FIG. 11, the best configuration is chosen based on a predetermined selection rule. For instance, a minimum MOS or maximum latency requirement can be specified, so that the configuration that minimizes power consumption while satisfying the QoS threshold is chosen. In the process 1100, the UE 116 determines the set of candidate UE configurations 715, and then uses the QoS estimation module 705 and the power consumption estimation module 905 to estimate the QoS metric 710 and the power consumption metric 910 of each configuration in the candidate set. Configurations that achieves an QoS estimate higher than a predetermined threshold are chosen for further consideration. If no such configuration exists, the configuration that achieves the maximum estimated QoS is selected. Otherwise, the configuration that achieves the smallest amount of power consumption among the selected set is selected.

If latency is the QoS metric 710, the QoS threshold may be the 98th latency requirement derived from the PDB specified in 3GPP TS 23.501. The specific requirement will depend on the application, for instance, clouding gaming requires smaller latency compared to web browsing. If MOS is the QoS metric 710, a MOS threshold can be chosen, which also be application-specific. For instance, a MOS range of 4.3-5.0 is found to translate to a user being very satisfied for call quality, whereas a MOS of 4.5 may be required for standard definition (SD) or high definition (HD) video. Hence a reasonable MOS threshold may be 4.3 for voice calling and 4.5 for video streaming. The MOS parametric models specified by ITU also provides a maximum MOS (typically smaller than 5.0) for the application, which can be used when designing the MOS threshold.

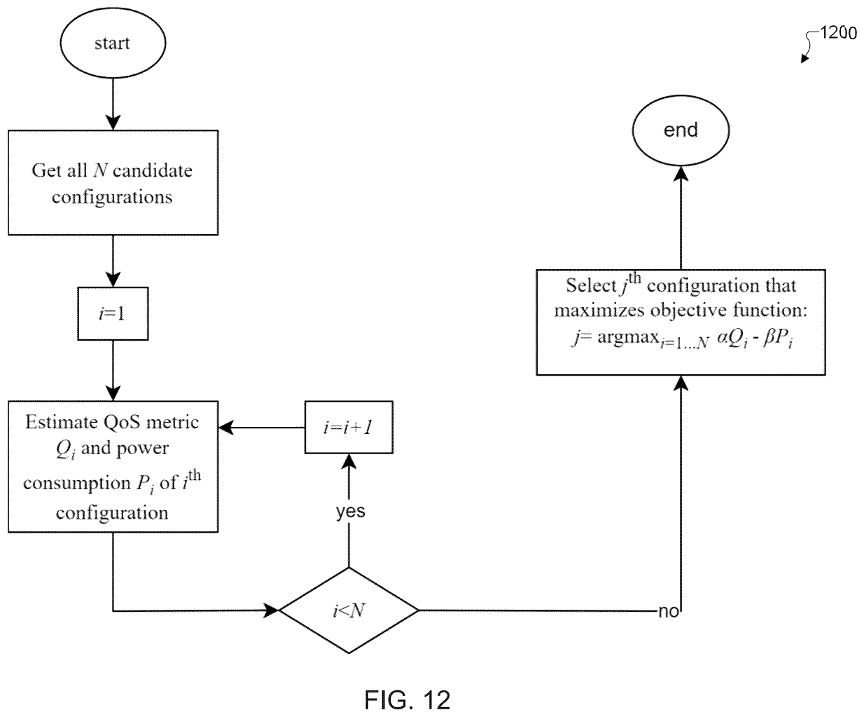

Alternatively, an objective function can be designed as a weighted sum of the QoS metric 710 and the negative of the power consumption metric 910. For example, FIG. 12 illustrates another example process 1200 for configuration adaptation according to embodiments of the present disclosure. In the process 1200, a configuration is selected that optimizes the weighted sum of the QoS metric 710 and the power consumption metric 910.

As illustrated in FIG. 12, the UE 116 determines the set of candidate UE configurations 715 and estimates the QoS metric 710 and the power consumption metric 910 of each. The configuration maximizing the objective function is selected. An example objective function is:

$$U = α {Q}_{i} - β {P}_{i} .$$

where Qᵢ, Pᵢ are the QoS estimate and power consumption estimate of the ith candidate configuration.

The weights on QoS and power consumption are design parameters to balance the tradeoff between QoS and power consumption. The QoS metric 710 and the power consumption metric 910 may be normalized to have the same scale and unit. For instance, they may be normalized by their maximum values so that both are unitless and have a range from 0 to 1 or −1. If MOS is used as the QoS metric 710, it may be normalized by 5, which is the maximum MOS. The power consumption metric 910 may be normalized by the maximum possible power consumption, which assumes the most power-hungry configuration (i.e., highest bandwidth, largest number of MIMO layers, etc.) while the UE 116 is on and transmits/receives in all applicable slots.

The UE 116 can select its preferred configuration every τ seconds if the UAI prohibit timer has elapsed. Both the selection periodicity τ and the QoS and power consumption forecast horizon T are design parameters and can be optimized as hyperparameters through experiments. Example values of these parameters are τ=0.5s and T=1s. A smaller τ and larger T will likely achieve better performance at the cost of higher computation complexity. In general, τ should be chosen to be smaller or equal to T, whereas T should be the minimum time window that captures the short-term traffic pattern of data rate requirement.

Although FIGS. 4 through 12 illustrate various processes and details related to UE power and QoS optimization using AI, various changes may be made to FIGS. 4 through 12. For example, various components in FIGS. 4 through 12 could be combined, further subdivided, or omitted and additional components could be added according to particular needs. In addition, various operations in FIGS. 4 through 12 could overlap, occur in parallel, occur in a different order, or occur any number of times.

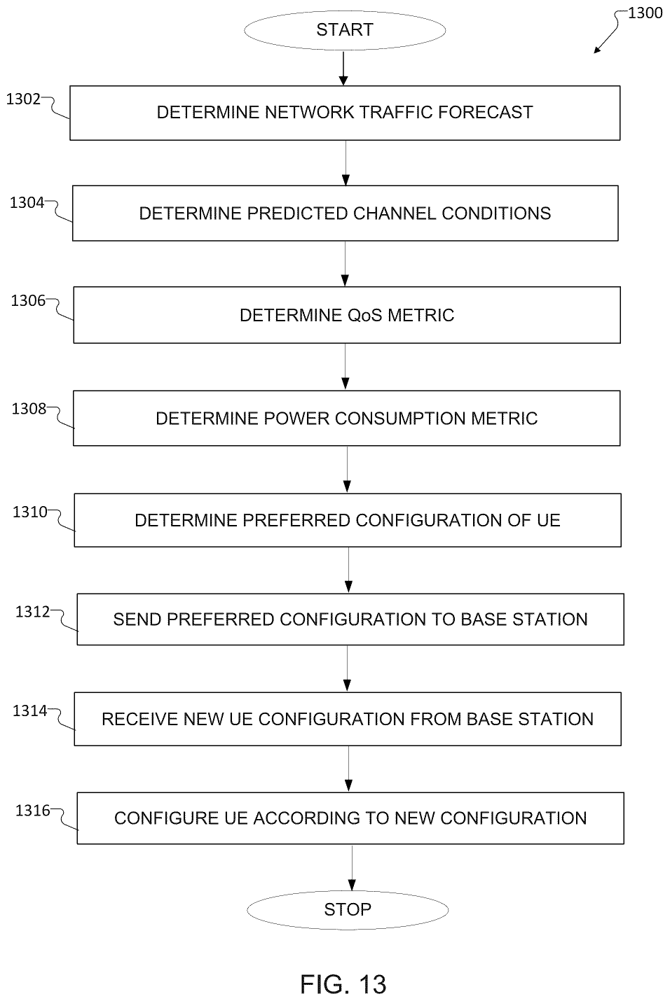

FIG. 13 illustrates a method 1300 for UE power and QoS optimization using AI according to embodiments of the present disclosure, as may be performed by one or more components of the network 100 (e.g., the UE 116). The embodiment of the method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

As illustrated in FIG. 13, the method 1300 begins at step 1302. At step 1302, the UE determines a network traffic forecast using a trained encoder-decoder based traffic forecast network that receives time series traffic history as an input. This could include, for example, the UE 116 using the traffic forecasting module 500 to determine the network traffic forecast 520, such as shown in FIG. 5.

At step 1304, the UE determines one or more predicted channel conditions using a trained encoder-decoder based channel condition prediction network that receives time series channel quality history as an input. This could include, for example, the UE 116 using the channel condition prediction module 600 to determine the predicted channel conditions 620, such as shown in FIG. 6.

At step 1306, the UE determines a QoS metric of the UE based on the network traffic forecast and the predicted channel condition. This could include, for example, the UE 116 using the QoS estimation module 705 to determine the QoS metric 710, such as shown in FIG. 7.

At step 1308, the UE estimates a power consumption of the UE based on the network traffic forecast and the predicted channel condition. This could include, for example, the UE 116 using the power consumption estimation module 905 to determine a power consumption metric 910, such as shown in FIG. 9.

At step 1310, the UE determines a preferred configuration of the UE based on side information about the UE. The side information can include the network traffic forecast, the predicted channel condition, an identification of applications executing on the UE, or any combination of these. The preferred configuration of the UE is selected from multiple candidate configurations in order to minimize the power consumption of the UE while maintaining a satisfactory QoS. This could include, for example, the UE 116 performing one of the processes 1100 or 1200, shown in FIGS. 11 and 12, to determine the best UE configuration. These processes 1100 and 1200 can represent (or be represented by) operation 415 shown in FIG. 4.

At step 1312, the UE sends the preferred configuration of the UE to a base station via a UAI framework. This could include, for example, the UE 116 performing operation 430, in which the UE 116 sends the preferred configuration to the gNB 102 through UAI, such as shown in FIG. 4.

At step 1314, the UE receives a new configuration of the UE from the base station after the base station determines the new configuration based on the preferred configuration. This could include, for example, the UE 116 receiving the new configuration from the gNB 102 in operation 445, such as shown in FIG. 4.

At step 1316, the UE configures itself according to the new configuration. This could include, for example, the UE 116 performing operation 450 in which the UE 116 switches to the new configuration, such as shown in FIG. 4.

Although FIG. 13 illustrates one example of a method 1300 for UE power and QoS optimization using AI, various changes may be made to FIG. 13. For example, while shown as a series of steps, various steps in FIG. 13 could overlap, occur in parallel, occur in a different order, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
determining a preferred configuration of a user equipment (UE) based on side information about the UE;
sending the preferred configuration of the UE to a base station via a UE assistance information (UAI) framework;
receiving a new configuration of the UE from the base station after the base station determines the new configuration based on the preferred configuration; and
configuring the UE according to the new configuration.

2. The method of claim 1, wherein the preferred configuration of the UE is selected from multiple candidate configurations in order to minimize power consumption of the UE while maintaining a satisfactory quality of service (QoS).

3. The method of claim 1, wherein the side information about the UE comprises at least one of:
an identification of applications executing on the UE;
a network traffic forecast determined using artificial intelligence; and
a predicted channel condition determined using artificial intelligence.

4. The method of claim 3, further comprising:
determining the network traffic forecast using a trained encoder-decoder based traffic forecast network that receives time series traffic history as an input.

5. The method of claim 3, further comprising determining the predicted channel condition using a trained encoder-decoder based channel condition prediction network that receives time series channel quality history as an input.

6. The method of claim 3, further comprising determining a quality of service (QoS) metric of the UE based on the network traffic forecast and the predicted channel condition.

7. The method of claim 3, further comprising estimating a power consumption of the UE based on the network traffic forecast and the predicted channel condition.

8. The method of claim 1, wherein the preferred configuration of the UE comprises at least one of:
a preferred connected mode discontinuous reception (CDRX) configuration;
a preferred maximum aggregated bandwidth;
a preferred maximum number of component carriers;
a preferred maximum number of multiple-input multiple-output (MIMO) layers; and
a preferred scheduling offset for cross-slot scheduling.

9. A user equipment (UE) comprising:
a processor configured to determine a preferred configuration of the UE based on side information about the UE; and
a transceiver operably connected to the processor, the transceiver configured to:
send the preferred configuration of the UE to a base station via a UE assistance information (UAI) framework, and
receive a new configuration of the UE from the base station after the base station determines the new configuration based on the preferred configuration,
wherein the processor is further configured to configure the UE according to the new configuration.

10. The UE of claim 9, wherein the processor is configured to select the preferred configuration of the UE from multiple candidate configurations in order to minimize power consumption of the UE while maintaining a quality of service (QoS).

11. The UE of claim 9, wherein the side information about the UE comprises at least one of:
an identification of applications executing on the UE;
a network traffic forecast determined using artificial intelligence; and
a predicted channel condition determined using artificial intelligence.

12. The UE of claim 11, wherein the processor is further configured to determine the network traffic forecast using a trained encoder-decoder based traffic forecast network that receives time series traffic history as an input.

13. The UE of claim 11, wherein the processor is further configured to determine the predicted channel condition using a trained encoder-decoder based channel condition prediction network that receives time series channel quality history as an input.

14. The UE of claim 11, wherein the processor is further configured to determine a quality of service (QoS) metric of the UE based on the network traffic forecast and the predicted channel condition.

15. The UE of claim 11, wherein the processor is further configured to estimate a power consumption of the UE based on the network traffic forecast and the predicted channel condition.

16. The UE of claim 9, wherein the preferred configuration of the UE comprises at least one of:
a preferred connected mode discontinuous reception (CDRX) configuration;
a preferred maximum aggregated bandwidth;
a preferred maximum number of component carriers;
a preferred maximum number of multiple-input multiple-output (MIMO) layers; and
a preferred scheduling offset for cross-slot scheduling.

17. A non-transitory computer readable medium comprising program code that, when executed by a processor of a device, causes the device to:
determine a preferred configuration of a user equipment (UE) based on side information about the UE;
send the preferred configuration of the UE to a base station via a UE assistance information (UAI) framework;
receive a new configuration of the UE from the base station after the base station determines the new configuration based on the preferred configuration; and
configure the UE according to the new configuration.

18. The non-transitory computer readable medium of claim 17, wherein the preferred configuration of the UE is selected from multiple candidate configurations in order to minimize power consumption of the UE while maintaining a quality of service (QoS).

19. The non-transitory computer readable medium of claim 17, wherein the side information about the UE comprises at least one of:
an identification of applications executing on the UE;
a network traffic forecast determined using artificial intelligence; and
a predicted channel condition determined using artificial intelligence.

20. The non-transitory computer readable medium of claim 19, wherein the program code further causes the device to determine the network traffic forecast using a trained encoder-decoder based traffic forecast network that receives time series traffic history as an input.
